(19) United States
(12) Patent Application Publication
(10) Pub. No.: US 2010/0278597 A1
(43) Pub. Date: Nov. 4, 2010

(54) DEVICE FOR TRANSPORTING POWDERS ALONG PIPES

(76) Inventor: Achille Borzone, Cernusco sul Naviglio MI (IT)

Correspondence Address: HARNESS, DICKEY & PIERCE, P.L.C., P.O. BOX 8910, RESTON, VA, 20195, US

(21) Appl. No.: 12/733,530

(22) PCT Filed: Sep. 16, 2008
(86) PCT No.: PCT/IB2008/002532

§ 371 Date: Jul. 6, 2010

(30) Foreign Application Priority Data
Sep. 18, 2007 (IT) MI2007A001799

(51) Int. Cl. B65G 53/40

(52) U.S. Cl. 406/108

(57) ABSTRACT

A device for transporting powders through pipes comprises at least one pumping unit (11, 111) in turn comprising a pumping chamber (12) with a powders inlet (13) and outlet (14) end, such ends being closable in a controlled manner by respective inlet and outlet controlled valves (15, 16). The pumping chamber (12) is laterally delimited by a wall (17) permeable to air but not to powder, such wall in turn being enclosed in a sealed shell (18). Present between the permeable wall and the internal wall of the sealed shell is an interspace (23) connected in a controlled manner to a source of pressure (21) in a first zone (19) in proximity to the inlet zones of the pumping chamber and to a source of vacuum (22) in a second zone (20) in proximity to the outlet ends of the pumping chamber.

The present invention refers to a device for pumping powders along pipes.

In the prior art, known are various types of devices for transferring products in powder form through pipes. In particular, this type of devices are used in powder painting systems, wherein it is necessary to suction the paints in powder form from the containers to convey them to the painting guns.

Among the various types of devices for pumping powders known are the ones employing one or more pumping chambers produced into which, in an alternating manner, is a vacuum and pressure for performing cycles for suctioning and blowing powders. Generally, the sources of pressure and vacuum are connected to the chamber through suitable porous septa to prevent the powder in the chamber from following the air flow. However, there are problems regarding the clogging of the porous septa, hence for example requiring frequent cleaning cycles. In order to optimize the filling and emptying of the chamber, it was also proposed that the connection points in the chamber of the pressure and vacuum sources be arranged separated and in proximity to the inlet and outlet of the chamber respectively. This reduces the need of cleaning and improves the movement of the powders. However, still of particular concern is the need of further enhancement of the uniformity of flow, the velocity of operation and reduction of the cloggings as well as the frequency of cleaning cycles. Attempts to meet such needs have led to extremely expensive and/or complex devices. The performances of such solutions are unsatisfactory especially in case of pumping chambers of particularly extended shape in order to increase the amount of powder transported.

A general object of the present invention is to overcome the abovementioned drawbacks by providing a device for pumping powders along pipes, such device being capable of providing the desired improvements, in a simple and relatively inexpensive manner.

For such purpose, it has been thought of providing, according to the invention, a device for transporting powders through pipes comprising at least one pumping unit in turn comprising a pumping chamber with a powder inlet and outlet end, such ends being closable in a controlled manner by respective inlet and outlet controlled valves, the pumping chamber being laterally delimited by a wall permeable to air but not to powders, such wall in turn being enclosed in a sealed shell, present between the permeable wall and internal wall of the sealed shell being an interspace which is connected in a controlled manner to a source of pressure in a first zone in proximity to the inlet end of the pumping chamber and a source of vacuum in a second zone in proximity to the outlet end of the pumping chamber.

For a better explanation of the innovative principles of the present invention and its advantages with respect to the prior art, described hereinafter, with the help of the only attached drawing, is a possible exemplified embodiment applying such principles.

Referring to the FIGURE, schematically shown is a pumping device, indicated in its entirety with 10, for transporting powders through pipes and made according to the invention.

The device comprises at least one pumping unit in turn comprising a pumping chamber 12 with a powder inlet end 13 and outlet end 14, such ends being closable in a controlled manner by respective inlet and outlet controlled valves 15, 16.

The pumping chamber is laterally delimited by a wall 17 made permeable to air but not to the powders to be transported, such wall in turn being enclosed in a sealed shell 18. The permeable wall 17 is extended at least between a first circumferential zone 19 in proximity to the inlet ends of the pumping chamber and a second circumferential zone 20 in proximity to the outlet ends of the pumping chamber. The first zone 19 is connected in a controlled manner to a source of pressure 21 and the second zone is connected in a controlled manner to a source of vacuum 22.

Present between the permeable wall 17 and the internal wall of the sealed shell 18 is a circumferential interspace 23 extended between the two zones to connect them.

The interspace between the two zones has a thickness advantageously comprised between 0.2 mm and 2 mm, preferably around 1 mm.

As clearly observable in the FIGURE, advantageously around the two zones 19 and 22 the interspace has a greater thickness, for example double.

Still advantageously, the pumping chamber is cylindrical-shaped, with the permeable wall made to form a pipe made of porous material with opposite ends respectively connected to the powder inlet and outlet ends. The porosity of the wall 17 is such to have pores of smaller dimensions with respect to the minimum dimensions of the granules of which the powders to be transported are made up of.

Advantageously, the controlled valves 15, 16 are pneumatic pinch valves. Such valves 15, 16 each comprise a flexible pipe 24, 25 passing through a relative control chamber 26, 27 connected in a controlled manner to a source of pressure 28, 29 to compress the pipe and close the valve (as schematically shown by means of a dashed line regarding the inlet valve). It was also deemed advantageous for the response velocity of the valve and, consequently, for the performances of the pumping unit, that the control chamber be also connected in a controlled manner to a source of vacuum 30, 31 to force the expansion of the pipe and the opening of the valve. In such case, the use of two connections separated at the source of pressure and vacuum, as observable in the drawings, was deemed advantageous.

Used for cyclical and timed connection of the pumping unit to the various sources of pressure and vacuum, in such a manner to provide a complete pumping cycle, is a control device 32, advantageously a suitably programmed microprocessor, per se easily imaginable by a man skilled in the art, especially according to the following pump operation description.

During the step of suctioning the powder from the chamber, the outlet valve is closed and a vacuum is generated in the chamber through the source 22. Once the chamber is filled with powder, the inlet valve is closed and the outlet valve is opened. A pressure is generated in the chamber through the source 21, in such a manner that the powder is discharged through the outlet 14. Due to the completely porous wall structure and due to the shape of the interspace 23, the thrust force inside the chamber occurs through “a pressure wave” of the air flowing through the wall from an end of the chamber to the other as the powder is discharged. Analogously, “a suctioning wave” can be obtained upon the filling of the chamber.

By using the structure according to the invention, the operating velocity, the efficiency and constancy of flow were found to have considerably improved with respect to the solutions of the prior art. Furthermore, the air which from the blowing zone 19, reaches up to the suctioning zone 20, through the interspace 23, contributes during each blowing cycle to clean the porous septum for the subsequent suctioning step, thus obtaining the self-cleaning function of the unit.

It was found advantageous that, for the step of filling the pumping chamber with powder from the inlet 13, the inlet and outlet controlled valves first be both closed, then that the pumping chamber be connected to the source of vacuum and subsequently that the inlet valve be opened to suction the powder into the pumping chamber. On the other hand, regarding the step of emptying powder from the pumping chamber through the outlet 14, it was found advantageous that the inlet and outlet controlled valves be first closed, the pumping chamber be connected to the source of pressure and then or simultaneously the outlet valve be reopened to blow the powder out of the pumping chamber.

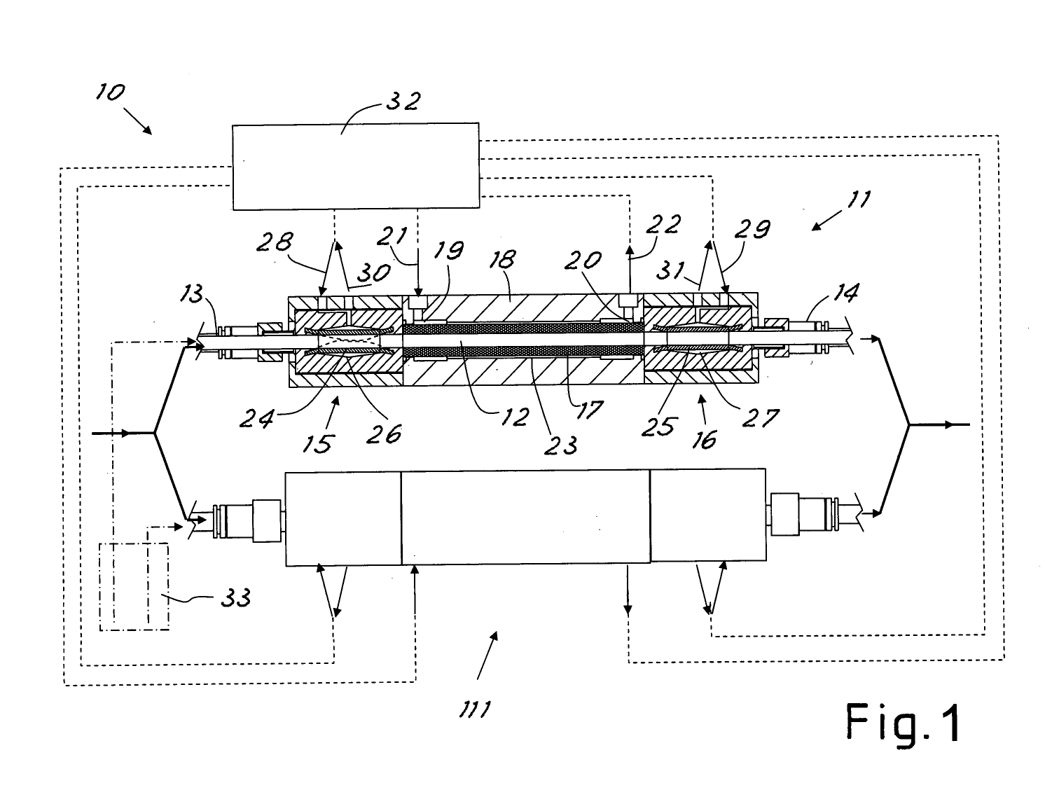

As observable still in FIG. 1, in order to obtain a uniformity of flow, there are at least two pumping units in the device 10 connected parallel to each other. The second unit, indicated with 111 is identical to the abovementioned unit 11 and thus not described or shown herein in detail. The parallel units can also be more than two.

Though the parallel units can be connected to their inlet by means of a fitting Y (analogously to their outlet), for a greater operation velocity and efficiency it was found advantageous that such units be connected in an independent manner through separate pipes to a container (indicated with 33) holding the powders to be suctioned, as indicated with the dash-dot line in FIG. 1.

The control unit 32 operates the controlled valves and supplies the interspaces of the various pumping units with pressure and vacuum in such a manner to provide a combined action of the various units in such a manner to obtain a substantially constant powder flow in exit. The operation of the various units shall thus be cyclical, alternating and, if required or deemed necessary, partially overlapped.

By using the described structure it was found possible and advantageous to obtain cycle times of 200-600 ms.

At this point it is clear how the preset objects have been attained. By means of a device according to the invention, obtained among others is an ideal operation with low maintenance requirements and high efficiency.

By using an interspace with a calibrated gap with respect to the porous pipe, a directional flow added to the emptying pressure of the pumping chamber is obtained. This flow, coming from the inlet 21 through the pressure chamber at the widened zone, has a longitudinal flow distribution tangential with respect to the external of the porous pipe and which, through the porous wall, is added to the primary flow inside the chamber, creating a quick exit “massage” from the chamber towards the valve (16).

This construction also allows an “easy” fluxing method, upon each operation cycle, of the permeable wall, intended to fill the pumping chamber through the vacuum in the opposite half-cycle.

This construction of the body of the valve leads to good operation results also with the extended versions of the chamber. The extended size solutions allow increasing the amount of powder paints transported (greater volumes available considering the same internal diameter) maintaining less strenuous cycle rhythms both for components of the first pump itself and for the electro-pneumatic valves controlling the operation cycles.

Obviously, the aforedescribed description of an embodiment applying the innovative principles of the present invention is provided with the purpose of exemplifying such innovative principles and thus shall not be deemed restrictive for the scope of the patent described herein. In particular, the control pneumatic circuit of the various units can be made in various known ways.

1. A device for transporting powders through pipes, the device comprising:
at least one pumping unit;
wherein the at least one pumping unit includes:
a pumping chamber;
wherein the pumping chamber includes:
an inlet end; and
an outlet end;
wherein the inlet end is closable in a controlled manner by an inlet controlled valve,
wherein the outlet end is closable in a controlled manner by an outlet controlled valve,
wherein the pumping chamber is laterally delimited by a first wall,
wherein the first wall is permeable to air but not to powder,
wherein the first wall is enclosed in a sealed shell,
wherein an interspace is present between the first wall and an internal wall of the sealed shell,
wherein the interspace is connected in a controlled manner to a source of pressure in a first zone in proximity to the inlet end of the pumping chamber,
wherein the interspace is connected in a controlled manner to a source of vacuum in a second zone in proximity to the outlet end of the pumping chamber, and
wherein the interspace has a greater thickness around the first and second zones than between the first and second zones.

2. The device of claim 1, wherein the interspace, between the first and second zones, has a thickness greater than or equal to 0.2 mm and less than or equal to 2 mm.

3. (canceled)

4. The device of claim 1, wherein the pumping chamber is cylindrical-shaped.

5. The device of claim 1, wherein the inlet controlled valve is a pinch valve, with a flexible pipe passing through a control chamber connected in a controlled manner to the source of pressure, in order to compress the flexible pipe and close the pinch valve.

6. The device of claim 5, wherein the control chamber is connected in a controlled manner to a source of vacuum in order to force expansion of the flexible pipe and opening of the pinch valve.

7. The device of claim 6, wherein connection of the control chamber to the sources of pressure and vacuum occurs through two separate connections.

8. The device of claim 1, wherein the permeable wall includes a pipe made of porous material,
wherein a first end of the pipe is connected to the inlet end, and
wherein a second end of the pipe is connected to the outlet end.

9. The device of claim 1, wherein during filling of the pumping chamber with powder, the inlet and outlet controlled valves are initially closed, the pumping chamber is connected to the source of vacuum, and then the inlet controlled valve is opened to suction the powder into the pumping chamber.

10. The device of claim 1, wherein during emptying of powder from the pumping chamber, the inlet and outlet controlled valves are initially closed, the pumping chamber is connected to the source of pressure, and the outlet valve is opened to blow the powder out of the pumping chamber.

11. The device of claim 1, further comprising:
at least two pumping chambers;
wherein the at least two pumping chambers are arranged in a parallel manner,
wherein a control unit operates the controlled valves of the at least two pumping chambers,
wherein the control unit supplies the interspaces of the at least two pumping units with pressure and vacuum to provide a combined action of the at least two pumping units in such a manner so as to obtain a substantially constant total flow of powder from the at least two pumping chambers.

12. The device of claim 11, wherein the at least two pumping units are connected in an independent manner through separate pipes to a container of the powder to be suctioned.

13. The device of claim 1, wherein the interspace, between the first and second zones, has a thickness of about 1 mm.

14. The device of claim 1, wherein the outlet controlled valve is a pinch valve, with a flexible pipe passing through a control chamber connected in a controlled manner to the source of pressure, in order to compress the flexible pipe and close the pinch valve.

15. The device of claim 14, wherein the control chamber is connected in a controlled manner to a source of vacuum in order to force expansion of the flexible pipe and opening of the pinch valve.

16. The device of claim 6, wherein connection of the control chamber to the sources of pressure and vacuum occurs through two separate connections.

17. The device of claim 1, wherein during emptying of powder from the pumping chamber, the inlet and outlet controlled valves are initially closed, the pumping chamber is connected to the source of pressure, and then the outlet valve is opened to blow the powder out of the pumping chamber.
